(19) United States
(12) Patent Application Publication
(10) Pub. No.: US 2008/0316868 A1
(43) Pub. Date: Dec. 25, 2008

(54) MULTIPLE-COOKING TIMING SYSTEM

(76) Inventor: Paula Sardis, Katy, TX (US)

Correspondence Address: KEELING PATENTS AND TRADEMARKS, 3310 KATY FREEWAY, SUITE 100, HOUSTON, TX, 77007, US

(21) Appl. No.: 11/765,856

(22) Filed: Jun. 20, 2007

(51) Int. Cl. A47J 45/10; A41D 13/08; G04F 1/00; G04G 17/00; A41D 19/015

(52) U.S. Cl. 368/10; 16/435; 2/16; 2/160

(57) ABSTRACT

The invention comprises a timing system for use in kitchen applications. The timing system includes a potholder or oven mitt with a timing device integrally attached thereto. The timing device contains an audible or visual alarm that alerts the user to the passage of the desired time. The timing device may be removably attached to the potholder or oven mitt.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to potholders in general, and more particularly to a timing system comprising a timing device integrally attached to a potholder.

2. Description of the Related Art

A common problem encountered in meal preparation revolves around the general necessity to distinguish which cooking vessel is associated with which timing device. The prior art discloses the use of timing devices as integrated into a particular cooking vessel; however, the majority of households currently house and utilize a plurality of cookware that is not fitted with such devices. It would be desirable to most to utilize the cookware they currently own rather than replace their entire stock with such prior art cooking vessels with timers.

The use of timers in connection with cooking vessels and timepieces in relation to gloves is known in the art as described in the following U.S. Patents.

U.S. Pat. No. 2,192,600, issued to Carl Lurtz on Mar. 5, 1940, discloses a timing mechanism combined with a whistle contained in the cover of a cooking receptacle. At the conclusion of a timed period, the whistle is aligned with an orifice in the cooking receptacle. This alignment allows steam to pass through the whistle which then signals the end of the time period.

U.S. Pat. No. 4,451,156, issued to Gerd Kloppsteck on May 29, 1984, discloses a cooking ware lid with a retaining knob that houses a bell timer.

U.S. Pat. No. 4,766,611, issued to Young S. Kim on Aug. 30, 1988, discloses a glove with a removable watch that contains Velcro hooks for attachment to a flap on the glove containing Velcro loops.

U.S. Pat. No. 5,644,552 and U.S. Design Pat. 382,767, issued to Chang-hsing Lien on Jul. 1, 1997 and Aug. 26, 1997 respectively, disclose a lid with a timer wherein the timer is situated in a circular recess located in the center of the lid.

U.S. Pat. Nos. 6,578,469 and 6,860,192, issued to Richard Sharpe on Jun. 17, 2003 and Mar. 1, 2005 respectively, disclose a digital frying pan containing indications of temperature and/or food doneness digitally displayed on the handle. Audible and/or visual indicators warn of programmed events, e.g., cooking time, temperature or food doneness. The removal of the handle electronics, which is preferably thermally shielded, for use on different sized pans or for ease of washing is also disclosed.

U.S. Pat. No. 6,580,662, issued to Stephen Vassallo on Jun. 17, 2003, discloses a food timer attachable to a cooking surface that includes a temperature monitor, which begins the timing mechanism once a pre-determined temperature is achieved.

U.S. Pat. No. 7,028,605, issued to Edward S. Owen, et al on Apr. 18, 2006, discloses a timer that attaches to a cooking vessel that includes a slide valve. The slide valve is set at a first position and emits a first signal once a pre-determined temperature is attained. The slide valve is then moved to a second position effectively terminating the first signal while simultaneously actuating the timing mechanism. A second signal is activated at the expiration of the set time interval.

U.S. Pat. No. 7,088,642, issued to Randall Cornfield on Aug. 8, 2006, discloses a cooking vessel with a lid and a timer removably associated with said lid. The timer may be attached to the lid handle during operation or removed and placed in a separate area or kept with the user while in use. The timer is also removable for ease of washing the vessel. A dove-tail joint is specifically disclosed as a means for attaching the timer to the cooking appliance.

U.S. Pat. No. 7,124,447, issued to Thomas J. Arganese on Oct. 24, 2006, discloses a glove with a mating ring sewn or glued into the material for accepting and mating with a watch head containing a snap-on rim along the periphery.

U.S. application Ser. No. 10/096,222, filed by Chris Chilton, published on Sep. 11, 2003, discloses a cooking pot with a plurality of measurement markings contained within the container area. The cooking pot contains a handle with a device that may function as a timer.

U.S. application Ser. No. 11/455,184, filed by Michael B. Ronci, published on Dec. 21, 2006 discloses a coffee pot with a manually activated timer built into the handle. The display shows the elapsed time since the previous resetting of the timer in order to track the freshness of the coffee.

U.S. application Ser. No. 11/428,526, filed by Eduardo E. Drake, published on Jan. 11, 2007, discloses a removable timer that can sense the opening of a door and actuate a visible or audible alarm. The attaching means comprise a magnet, reusable adhesive or suction cup.

The prior art does not disclose, either singularly or in combination, the present invention consisting of a timing device integrally attached to a potholder or oven mitt.

It is an object of the present invention to provide a timing device integrally attached to a potholder wherein the potholder is capable of being removably attached to the handle of a cooking vessel, the timing device operable to signal the end of a designated time period in relation to that particular cooking vessel.

It is a further object of the present invention to provide one or more timing systems, each comprising a timing device integrally attached to a potholder, in order to track, in a cost-effective manner, the cooking time of individual cooking vessels.

It is a further object of the present invention to provide a timing device integrally attached to a potholder that may be utilized interchangeably with any number of cooking vessels.

It is a further object of the present invention to provide a timing device integrally attached to a potholder or oven mitt that may be retained by the user in order to signal the end period of a designated time in a location away from the associated cooking vessel, oven, microwave, toaster oven or the like.

### BRIEF SUMMARY OF THE INVENTION

The present invention comprises a timing system for use in kitchen applications. The timing system includes a potholder with a timing device integrally attached thereto. The desired time is entered into the timing device. The timing system removably attaches to the handle of a cooking vessel. This allows the desired time for that particular cooking vessel to be monitored. An audible or visual alarm is engaged once the desired time has elapsed. The timing device may be removably attached to the potholder.

Alternatively, the timing system may include an oven mitt with a timing device integrally attached thereto. The timing system may be retained by the user for notification of the elapsed time in a location away from the cooking vessel or cooking apparatus.

In an alternative embodiment, the timing device may be removably attached to the potholder or oven mitt.

Other features and advantages of the invention will be apparent from the following description, the accompanying drawings and the appended claims.

### BRIEF DESCRIPTION OF THE DRAWINGS

For a more complete understanding of the present invention and the advantages thereof, reference is now made to the following Detailed Description of an Example Embodiment of the Invention, taken in conjunction with the accompanying drawings, in which:

FIG. 1 is a perspective view of the present invention.

FIG. 1A is a skewed perspective view of the timing device.

FIG. 2A is a perspective top view of a type of cooking vessel.

FIG. 2B is a perspective top view of the present invention applied to the cooking vessel of FIG. 2A depicting the preferred embodiment.

FIG. 3A is a perspective back view of an alternative embodiment of the present invention.

FIG. 3B is a perspective front view of an alternative embodiment of the present invention.

FIG. 4 is a perspective view of an alternative embodiment of the present invention.

FIG. 4A is a perspective view of a cooking vessel.

FIG. 4B is a perspective view of the embodiment of FIG. 4 as applied to the cooking vessel of FIG. 4A.

FIG. 5 is a perspective view of an alternative embodiment of the present invention.

FIG. 6 is a perspective view of an alternative embodiment of the present invention.

### DESCRIPTION OF THE INVENTION

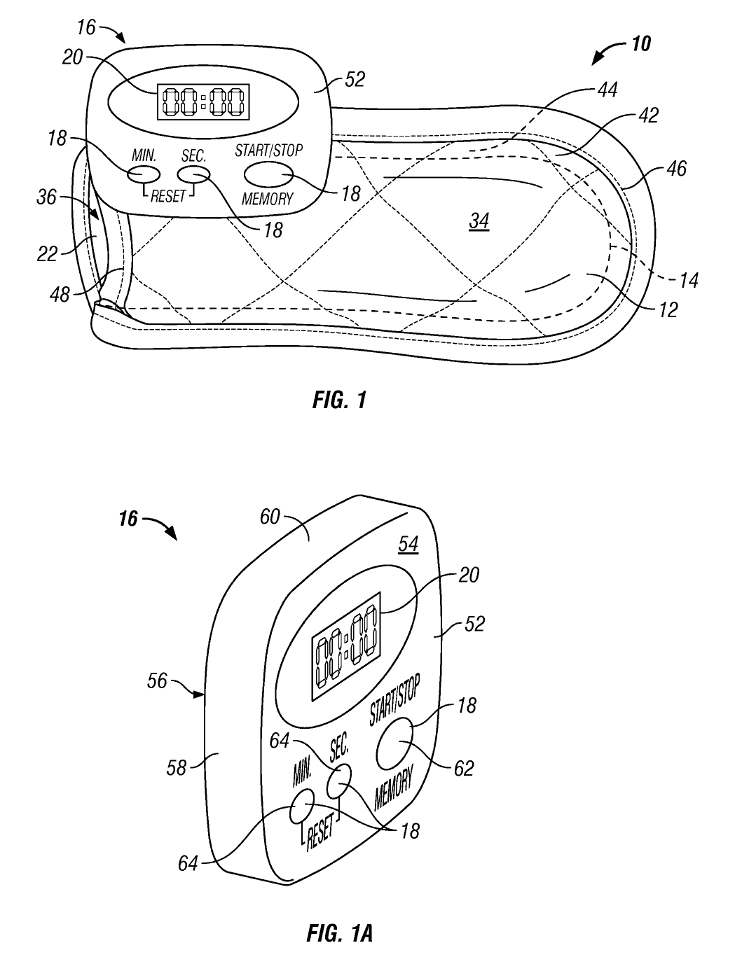

The invention and its advantages are best understood by referring to the drawings, like numerals being used for like and corresponding parts of the various drawings. FIGS. 1-3B show an exemplary embodiment of the timing system 10 of the present invention.

Referring to FIG. 1, the present invention 10 generally comprises a potholder 12 and a timing device 16. Although three versions of a potholder 12, 50, 100 and one version of an oven mitt 40 will be described herein in order to describe the present invention 10, any commercially available potholder 12, 50, 100, oven mitt 40 or the like, of any shape and size, may be utilized in conjunction with the present invention 10 while retaining the novelty and inventive inspiration expressed herein. Similarly, although a version of timing device 16 will be explained in detail herein in order to describe the present invention 10, any commercially available timing device 16 may be utilized in conjunction with the present invention 10 while retaining the novelty and inventive inspiration expressed herein.

A potholder 12 in an exemplary embodiment is formed in a generally truncated oval shape. The potholder 12 is composed of two members 42,44. Both members 42,44 have an outside surface 34 and a corresponding directly opposite inside surface 36. At least one layer of insulating material, not shown, is disposed intermediate the outside 34 and inside 36 surfaces. The two members 42,44 are fixedly attached to each other about a majority of their periphery by a connecting seam 46. End seams 48 are fixedly attached at an insert end opening 22 along each independent member 42,44. The end seams 48 define the insert end opening 22 of the potholder 12.

Inside surfaces 36 of the two members 42,44, the connecting seam 46 and the insert end opening 22 define an internal channel 14 of the potholder 12.

Referring to FIG. 1A, a timing device 16 is generally comprised of a housing 52, display 20 and timer controls 18. The housing 52 is generally cuboidal in shape; however, it is within the scope of this invention for the housing 52 to comprise other shapes, such as spherical, parallelepiped, polygonal, spheroid or any other desirable configuration.

The housing 52 includes a front surface 54 and a back surface 56. The front surface 54 and back surface 56 are integrally attached by a sidewall 58. The sidewall 58 extends the length of the longitudinal perimeter of the housing 52. A battery compartment, not shown, is contained within the housing 52.

The display 20 is located on the front surface 54. The display is generally rectangular in shape and is disposed proximal the top 60 of the housing 54; however, as with the shape of the housing 52, it is within the scope of this invention for the display 20 to comprise other shapes not depicted herein. The display 20 is operatively connected to the battery compartment, not shown.

The timer controls 18 are disposed at the front surface 54 proximal the display 20. The display 20 is disposed intermediate the top 60 of the housing 52 and the timer controls 18. It is within the scope of this invention for the depicted orientation of the display 20 and the timer controls 18 to be reversed or to be positioned in any other desirable orientation.

The timing device 16 is controlled by the timer controls 18. Generally, the timer controls 18 consist of three independently operated buttons 62,64. The activation button 62 activates or deactivates the timing device 16 when pressed. The remaining buttons are the time increment controls 64 of the timer controls 18. Additional timing controls 18 may be added as desired. A desired duration of time is entered utilizing the timer controls 18 and the timing device 16 is activated by pressing the activation button 62. Once the desired time is reached, an audible or visual signal from the timing device 16 will activate. The pressing of the corresponding timer control 18 will discontinue this signal.

Referring to FIG. 1, the timing device 16 is fixedly attached to the potholder 12 adjacent the insert end opening 22 in an exemplary embodiment. Alternatively, the timing device 16 may be placed in another desired location on the potholder 12. This attachment may be achieved by utilizing any commercially available attachment means. In one exemplary embodiment, the timing device 16 is fixedly attached to the potholder 12 through the use of Amazing Goop® Craft Glue. Amazing Goop® is a registered trademark of Eclectic Products, Incorporated.

In an alternative embodiment, the timing device 16 may be removably attached to the potholder 12 such as by a clip, not shown, or cooperating hook and loop fasteners.

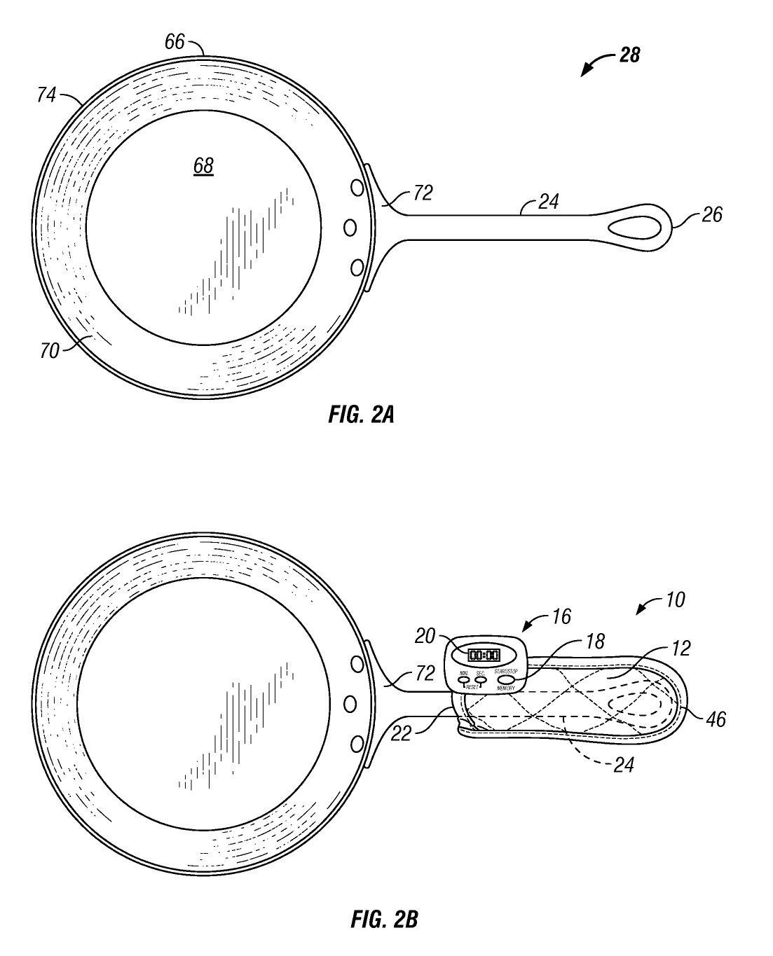

Referring to FIGS. 2A and 2B, a cooking vessel 28 is shown comprising a body 66 and a handle 24. The body 66 contains an annular member 70 that extends radially about the cooking surface 68. The annular member 70 is fixedly attached distal the top end 74 to the cooking surface 68 about its periphery.

Attachment end 72 of the handle 24 is integrally attached to the body 66 at a point on the exterior of the annular member 70 that is intermediate the cooking surface 68 and the top rim 74.

The timing system 10 removably enshrouds the handle 24 in operation. This is achieved by placing the insert end opening 22 of the potholder 12 adjacent to the insert end 26 of the handle 24. The timing system 10 is then slipped onto and over the handle 24. The handle 24 rests within the internal channel 14 once inserted into the timing device 10 and the insert end opening 22 is disposed proximate the attachment end 72 of the cooking vessel 28.

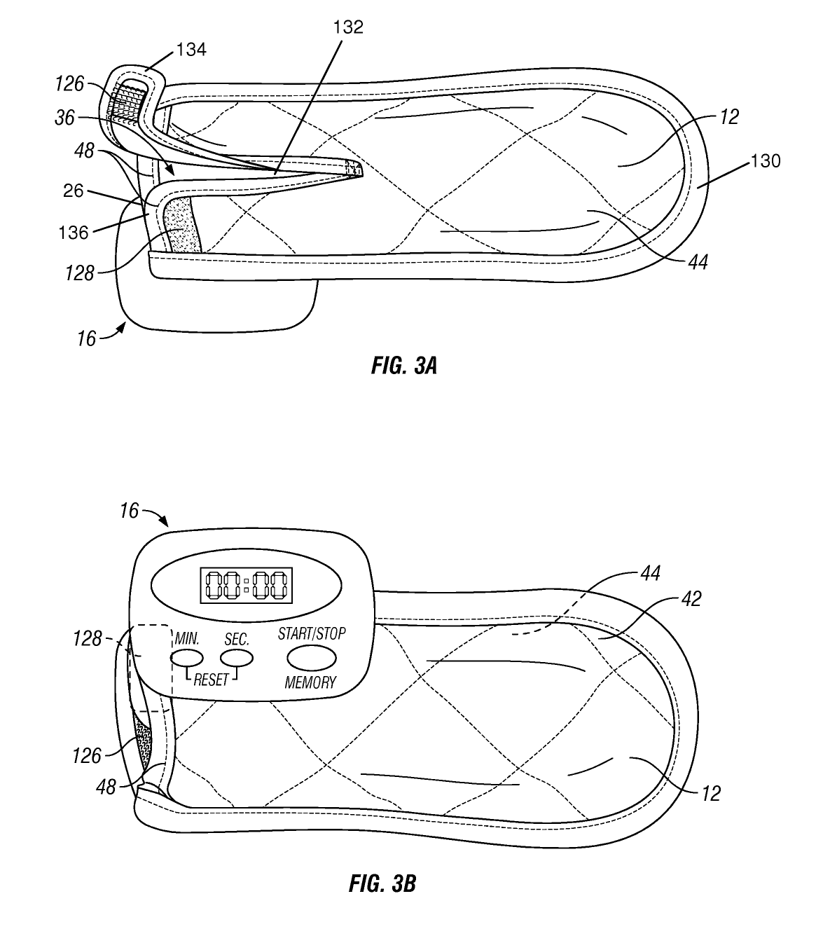

FIGS. 3A and 3B display alternative illustrative embodiments comprising a tightening device 126,128 for securing the potholder 12 to the handle 24, such as by way of a hook and loop fastener system or the like. The second member 44 contains a longitudinal opening 132 ending at an approximate midpoint intermediate the insert end 26 and its distal end 130. The longitudinal opening 132 is disposed intermediate a second member strap 134 and a corresponding second member attachment area 136. The second member strap 134 overlaps the second member attachment area 136 of the second member 44 proximate the timing device 16. A first tightening device fastener component 126 is fixedly attached to the second member strap 134 on the inside surface 36 of the second member 44 proximate the end seams 48. A corresponding second tightening device fastener component 128 is fixedly attached to the second member attachment area 136 on the outside surface 34 of the second member 44 proximate the timing device 16 and adjacent the end seam 48. In operation, once the timing system 10 is placed upon the handle 12, the second member strap 134 is positioned to overlap the second member attachment area 136 and tighten the timing system 10 onto the handle 12. The first tightening device fastener component 126 is then releasably fastened to the second tightening device fastener component 128 in order to maintain this tightened position.

The second illustrative embodiment in FIG. 3B shows the first tightening device fastener component 126 fixedly attached to the inside surface 36 of the first member 42. The corresponding second tightening device fastener component 128 is fixedly attached to the inside surface 36 of the second member 44. In operation, once the timing system 10 is placed upon the handle 12, the unencumbered edges of the first 42 and second 44 members are pressed together thereby engaging and removably attaching the first 126 and second 128 tightening device fastener components.

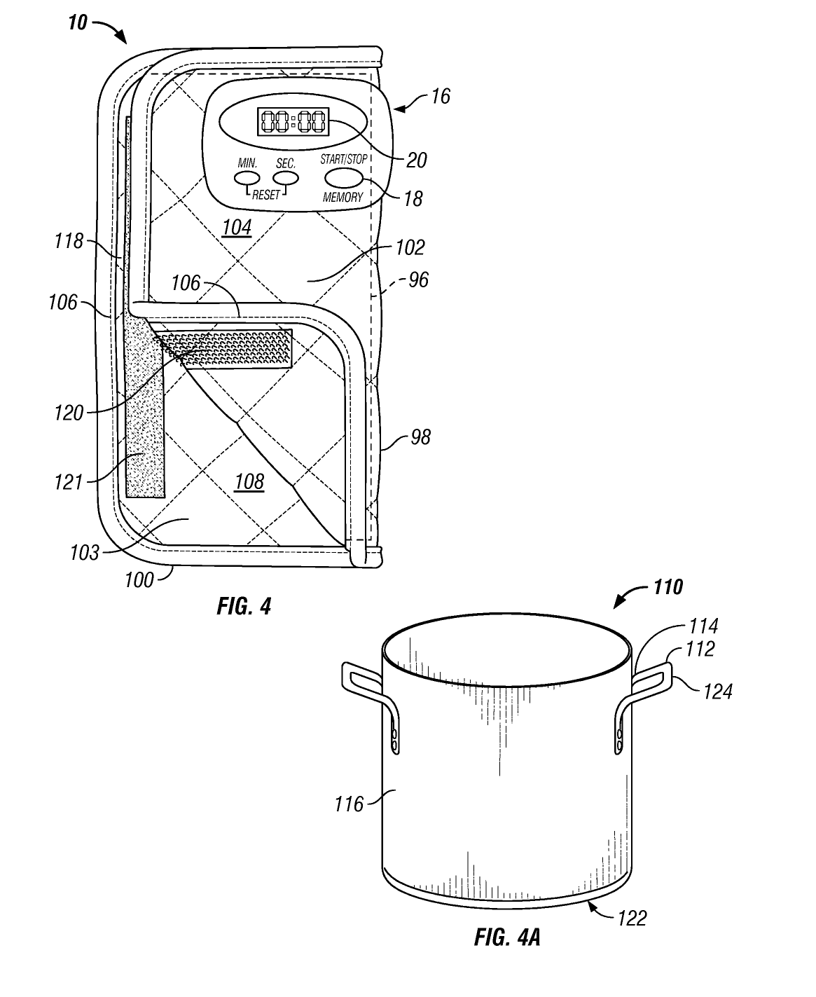

Referring to FIG. 4, a potholder 100 in an exemplary embodiment is formed in a generally square shape when laid flat. An end seam 106 is fixedly attached along the periphery of the potholder 100 at an insert end opening 118. The potholder 100 is composed of two continuous members 102,103. Both members 102,103 have an outside surface 104 and a corresponding opposite inside surface 108. At least one layer of insulating material, not shown, is disposed intermediate the outside 104 and inside 108 surfaces. The potholder 100 contains a folding seam 98 that effects a folded rectangular configuration. The end seams 106 define the insert end opening 118 of the potholder 100.

Inside surfaces 108 of the two adjacent members 102,103, the folding seam 98 and the insert end opening 118 define an internal channel 96 of the potholder 100.

The first member 102 and second member 103 inside surfaces 108 contain a hook and loop fastener system 120,121 proximate the end seams 106. The hook and loop fastener system has a first fastener component 120 attached to the inside surface 108 of the first member 102; and a second fastener component 121 attached to the inside surface 108 of the second member 103.

In the exemplary embodiment, the timing device 16 is attached to the potholder 100 proximate the seam 98. The timing device 16 may be placed in any desired location on the potholder 100.

Referring to FIGS. 4A and 4B, a cooking vessel 110 is shown comprising a body 116 and a handle 112. The body 116 is generally annular and extends radially about and is fixedly attached to a heating surface 122.

Attachment ends 114 of the handle 112 are integrally attached to the body 116 at a point on the exterior of the body member 116.

The timing system 10 removably enshrouds the handle 112 in operation. This is achieved by placing the insert end opening 118 of the potholder 100 adjacent to the insert end 124 of the handle 112. The timing system 10 is then slipped onto and over the handle 112. The handle 112 rests within the internal channel 96 once inserted into the timing device 10 and the insert end opening 118 is disposed proximate the attachment end 114 of the cooking vessel 110. The first fastener component 120 of the hook and loop system is releasably fastened to the second fastener component 121. This coupling prevents the timing system 10 from dislodging from the handle 112. Although a hook and loop fastener system has been described herein, any fastening system that is capable of being removably fastened will suffice.

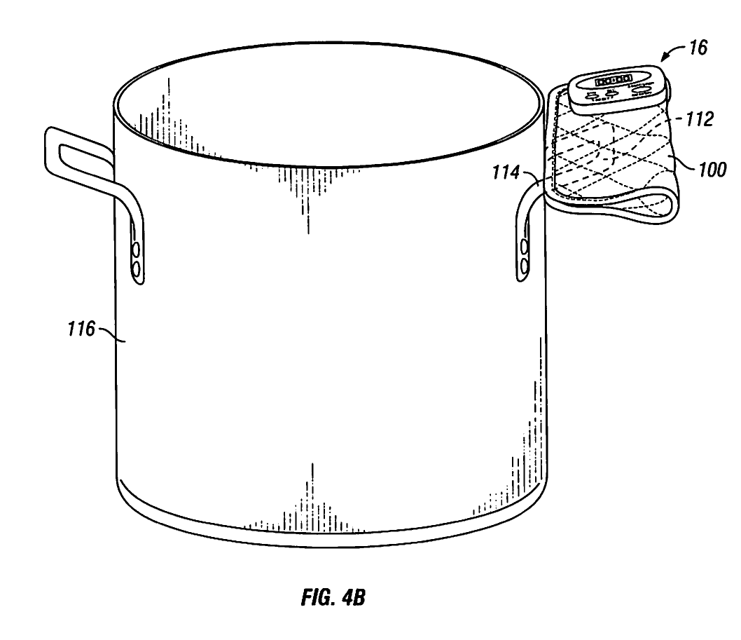

FIG. 5 depicts an alternative embodiment of the present invention 10. A potholder 50 is depicted containing a front member 76 and a back member 78. The potholder 50 is generally in a rectangular shape; however, it is within the scope of this invention for the potholder 50 to comprise other shapes not depicted herein. At least one layer of insulating material, not shown, is disposed intermediate the front 76 and back 78 members. The front 76 and back 78 members are attached along their periphery by a seam 80. The timing device 16 is attached to the potholder 50 at a corner adjacent to the seam 80; however, the timing device 16 may be attached in any other desirable location.

In an alternative exemplary embodiment, the timing device 16 may be removably attached to the potholder 50 by a clip, corresponding hook and loop fasteners or like attachment mechanism (not shown).

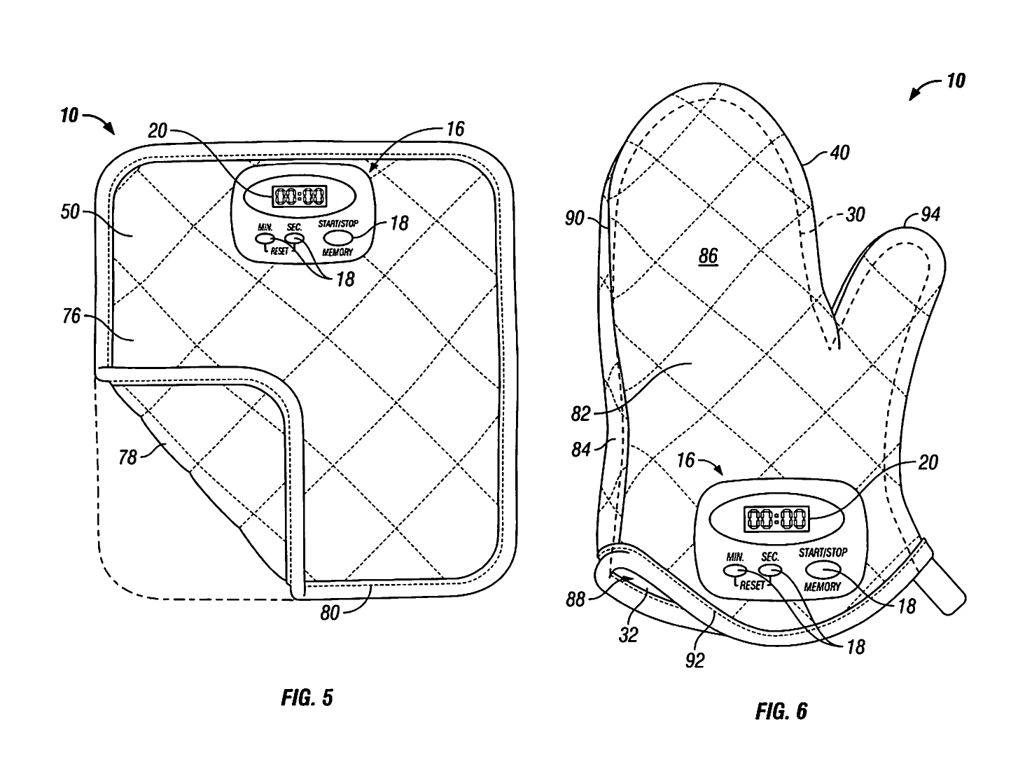

FIG. 6 depicts a further alternative embodiment of the present invention 10. An oven mitt 40 is depicted containing a first 82 and second 84 member. Both members 82,84 have an outside surface 86 and a diametrically opposed inside surface 88. At least one layer of insulating material, not shown, is disposed intermediate the outside 86 and inside 88 surfaces. The two members 82,84 are fixedly attached to each other about a majority of their periphery by an internal seam 90. The end seams 92 are fixedly attached at the insert end opening 32 along each independent member 82,84 of the oven mitt 40. The end seams 92 define the insert end opening 32.

The inside surfaces 88 of the two members 82,84 and the insert end opening 22 define the internal channel 30 of the oven mitt 12.

In operation, a user inserts their hand into the internal channel 30 through the insert end opening 32. The user's hand will lie intermediate the inside surfaces 88 of the first 82 and second 84 members within the internal channel 30. The thumb of the user's inserted hand will lie intermediate the inside surfaces 88 of the first 82 and second 84 members within the thumb portion 94 of the internal channel 30.

The timing device 16 is attached to the oven mitt 40 proximal the end seams 92 on the first member 82. Alternatively, the timing device 16 may be placed on the second member 84 proximate the end seams 92, depending upon the user's preference. Alternatively, the timing device 16 may be removably attached to the oven mitt 40, not shown.

The foregoing description of the invention illustrates a preferred embodiment thereof. Various changes may be made in the details of the illustrated construction within the scope of the appended claims without departing from the true spirit of the invention. The present invention should only be limited by the claims and their equivalents.

1. A multiple-cooking timing system comprising:
a potholder;
a timing device;
said timing device attached to said potholder;
said potholder having a first member and a corresponding second member;
said first and second members each generally formed in a truncated oval shape;
said first member having a first member inside surface, a first member outside surface, and a periphery;
said second member having a second member inside surface, a second member outside surface, and a periphery;
said first member and said second member arranged adjacent each other with said first member inside surface adjacent said second member inside surface such that the combined members define a common periphery;
a seam connecting said first member and said second member about a majority of the common periphery of said first and second member;
an unattached portion of said common periphery of said first member and said second member defining an insert end opening; and
said first and second member inside surfaces, said insert end opening and said connecting seam define an internal channel extending longitudinally within said potholder.

2. The system of claim 1, wherein said timing device is removably attached to said potholder.

3. The system of claim 1, further comprising:
at least one protrusion extending outwardly from said internal channel.

4. The system of claim 1, further comprising:
at least one layer of insulating material disposed intermediate said first member inside surface and said first member outside surface; and
at least one layer of insulating material disposed intermediate said second member inside surface and said second member outside surface.

5. The system of claim 1, further comprising:
said timing device having a front surface and a corresponding back surface;
said front and back surfaces integrally connected by a sidewall;
a display disposed on said front surface;
said display operatively connected to a power source;
at least one timer control disposed on said timing device; and
said timing device producing an alarm at a predetermined time interval.

6. The system of claim 5, wherein said alarm is audible.

7. The system of claim 1, further comprising:
a cooking vessel;
a handle;
said handle containing an attachment end and a distal handle end;
said handle fixedly attached to said cooking vessel at said attachment end; and
said potholder removably attached to said handle.

8. The system of claim 1, further comprising:
a hook and loop fastener system with a first fastener component and a corresponding second fastener component;
said first fastener component attached to said first member inside surface; and
said second fastener component attached to said second member inside surface.

9. The system of claim 1, further comprising:
a longitudinal opening on said second member beginning at said insert end opening;
said longitudinal opening disposed intermediate a second member strap and a corresponding second member attachment area;
a fastener system with a first fastener component and a corresponding second fastener component;
said first fastener component attached to said second member inside surface at said second member strap; and
said second fastener component attached to said second member outside surface at said second member attachment area.

10. (canceled)

11. The system of claim 18, further comprising:
a fastener system with a first fastener component and a corresponding second fastener component;
said first fastener component attached to said first member inside surface proximate said first member insert end; and
said second fastener component attached to said second member inside surface proximate said second member insert end.

12. (canceled)

13. A multiple-cooking timing system comprising:
a potholder;
a timing device;
said timing device attached to said potholder;
said potholder generally formed in a square shape containing a periphery; and
an end seam fixedly attached along the periphery of said potholder.

14. The system of claim 13, wherein said timing device is removably attachable to said potholder.

15. The system of claim 13, wherein;
said potholder contains an inside surface and an outside surface;
a fastener system with a first fastener component and a corresponding second fastener component;
said first fastener component attached to said inside surface proximate said end seam;
said second fastener component attached to said inside surface directly opposed to said first fastener component and proximate said end seam; and
said timing device attached to said outside surface.

16. The system of claim 15, further comprising:
at least one layer of insulating material disposed intermediate said inside surface and said outside surface.

17. (canceled)

18. A timing system comprising:
potholder;
a timing device;
said timing device attached to said potholder;
said potholder having a first member and a corresponding second member;
said first and second members each generally rectangular in shape;
said first member having a first member inside surface, a first member outside surface, and a periphery;
said second member having a second member inside surface, a second member outside surface, and a periphery;
a first member seam fixedly attached along the periphery of three contiguous sides of said first member defining a first member insert end;
a second member seam fixedly attached along the periphery of three contiguous sides of said second member defining a second member insert end;
said first member and said second member attached to one another about the periphery of their corresponding fourth side adjacent to said first and second member insert ends by a connecting seam; and
said first member inside surface is disposed adjacent said second member inside surface.

19. The system of claim 18, further comprising:
a timing device having a front surface and a corresponding back surface;
said front and back surfaces are integrally connected by a sidewall;
a display disposed on said front surface;
said display operatively connected to a power source;
at least one timer control disposed on said timing device;
said timing device producing an alarm at a predetermined time interval; and
said timing device is removably attached to said potholder.

20. The system of claim 18, further comprising:
at least one layer of insulating material disposed intermediate said first member inside surface and said first member outside surface; and
at least one layer of insulating material disposed intermediate said second member inside surface and said second member outside surface.

21. The system of claim 3, wherein said timing device is disposed proximate said insert end opening.
